(19) United States
(12) Patent Application Publication
(10) Pub. No.: US 2010/0285257 A1
(43) Pub. Date: Nov. 11, 2010

(54) REINFORCED, SELF ADHERING, SEE-THROUGH, CONSTRUCTION FLASHING TAPE

(76) Inventor: Matthew Bullock, McLean, VA (US)

Correspondence Address: KILE PARK REED & MCMANUS, 1200 NEW HAMPSHIRE AVE, NW, SUITE 570, WASHINGTON, DC, 20036, US

(21) Appl. No.: 12/463,164

(22) Filed: May 8, 2009

(51) Int. Cl. B32B 33/00

(52) U.S. Cl. 428/40.1

(57) ABSTRACT

A laminated, see through, concealed window flashing function including a flexible, transparent strip having a first and second side and first and second longitudinally edges. A layer of transparent adhesive coextensively covers one side of the flexible, transparent strip. A core layer of reinforcing is positioned upon a center portion of the transparent adhesive leaving edge margins on each side of the core layer. The width of the edge margins are such that in combination they comprise between approximately twenty five and fifty percent of the width of the construction flashing tape. The core layer is composed of a plurality of high denier fiber bundles that are positioned along the center of the tape with lateral gaps between adjacent bundles so that it is possible to see through the center of the tape. Finally a release strip is coextensively applied along the tape surface so that the tape can be stored in a roll and the release strip removed on site to apply the tape, as concealed flashing, around a window junction or the like.

### BACKGROUND OF THE INVENTION

This invention relates to an improved core reinforced, self-adhering, construction tape. More particularly, this invention relates to a novel, construction tape that has application as a see through, flashing tape around building windows and other vertically oriented openings and the like where a concealed, reinforced, flashing application is necessary or desirable.

In building construction, such as for example residential homes, vertical openings are created within exterior wall surfaces for installation of windows and the like with essentially junctions or joints that lie in a plane essentially normal to a ground surface such as between a factory assembled window, with framing, and stick or factory assembled building wall studs. The factory windows are mounted onto the building studs by staples or nails around a periphery of the windows.

In at least one study by the University of Illinois regarding Residential Heat Loss it was determined that heat loss through windows and doors during winter months is as much as 70% and air conditioning loss in the summer as much as 46%. This is attributable in large part by cracks and leaks around the periphery of windows which way be as much as 1/16th of an inch or more.

In order to complete a window installation with enhanced seal characteristics concealed flashing is usually used to create a moisture, vapor and air barrier around the window framing. In the past concealed window flashing included sheet metal or water proofing membranes such a bituminous fabric or plastic tapes depending on the anticipated site requirements.

This concealed construction flashing at least partially functioned to seal the window mounting against the ingress of dust and egress of heat or cool air flow into an ambient environment provided the seal is maintained.

In addition to the ingress and egress of air and heat and cooling losses, water intrusion around inadequately sealed window junctions can be problematic. In this, rain driven moisture that is able to migrate past an initial barrier can travel by capillary action and dry rot framing, stain interior wall board and even damage flooring materials and interior furnishings. Accordingly it would be highly desirable to provide an enhanced window flashing tape that would be secure in application and rugged against tearing so that air and moisture would be effectively blocked from undesirable transmission around window and framing junctions.

It would be highly desirable to provide an enhanced self adhering peripheral surface for window flashing and a concomitant ability to accurately see that the flashing tape is being applied along approximately the center of a peripheral window frame seam.

As a building or home settles concealed flashing is subject to stress and possible rupture or release from the surfaces of initial application creating the possibility of unwanted drafts or moisture invasion around the perimeter of a window installation. In this self-adhering plastic tape may be subject to release around the initial sealed edge surfaces. Alternatively the center of the tape may skew and tear as framing tends to sag or cant from an initial plumb condition—even by a relatively small degree of travel.

In addition to age related issues initial application of flashing tape in an accurate position can have an impact upon long term suitability of the concealed flashing for the intended purpose of application. Accordingly it would be desirable to be able to accurately apply a flashing tape during initial installation to provide the most optimum long term functionality for the construction.

Still further an effective window seal should be capable of accommodating a wide range of temperature gradients and remain tacky to facilitate a secure seal between a window frame and adjacent framing.

The problems suggested in the preceding are not intended to be exhaustive but rather are among many which may tend to reduce the effectiveness of concealed window flashing known in the past. Other noteworthy problems may also exist; however, those presented above should be sufficient to demonstrate that concealed window or other vertical junction flashing appearing in the past will admit to worthwhile improvement.

### SUMMARY OF THE INVENTION

One embodiment of the invention that is operable to provide a secure and long lasting concealed window flashing function comprises a see through construction tape that is formed with a flexible, transparent strip having a first and second side and first and second longitudinally edges. A layer of transparent adhesive coextensively covers one side of the flexible, transparent strip. A core layer of reinforcing is positioned upon a center portion of the transparent adhesive leaving edge margins on each side of the core layer. The width of the edge margins are such that in combination they comprise between approximately twenty five and fifty percent of the width of the construction flashing tape. The core layer is composed of a plurality of fiber bundles that are positioned along the center of the tape with lateral gaps between adjacent bundles so that it is possible to see through the center of the tape. Finally a release strip is coextensively applied along the tape surface so that the tape can be stored in a roll and the release strip removed on site to apply the tape, as concealed flashing, around a window junction or the like.

### THE DRAWINGS

Other aspects of the present invention will become apparent from the following detailed description of embodiments taken in conjunction with the accompanying drawings wherein:

FIG. 1 is an axonometric view showing a conventional residential home with vertically hung windows throughout the house;

FIG. 2 is an exploded view of a window and frame to be mounted into wall framing of a home and application of concealed flashing tape around the periphery of the window in accordance with the subject invention to operably seal the periphery of the window junction with the house framing studs or overlying sheets of wall material;

FIG. 3 is a perspective view of a roll of window flashing tape in accordance with the invention;

FIG. 4 is a cross-sectional view taken along section line 4-4 in FIG. 3 that shows internal structural details of the subject window flashing tape; and

FIG. 5 is a partial detail view of an application of the subject see through construction tape as concealed window flashing.

### DETAILED DESCRIPTION

### Context of the Invention

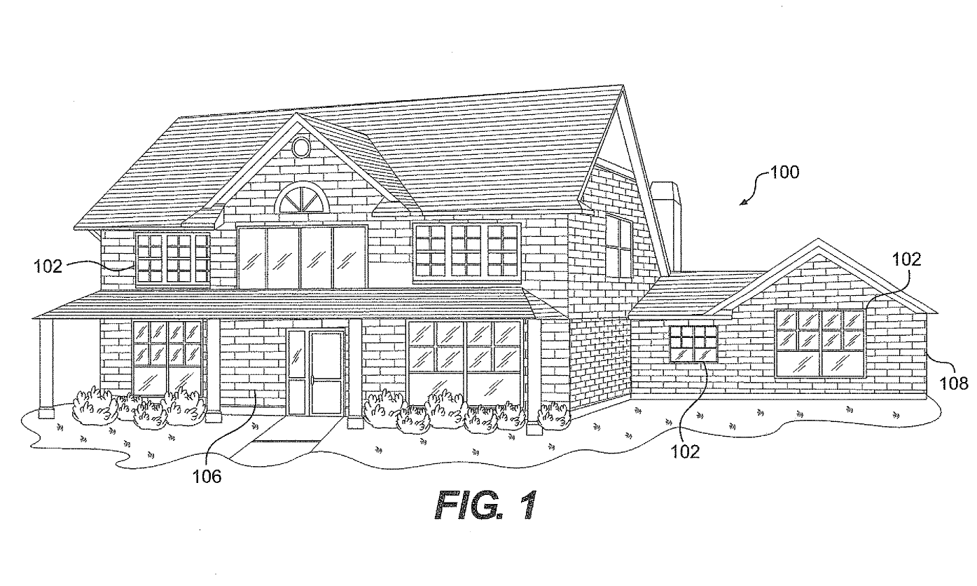

Turning now to the drawings, FIG. 1 shows an axonometric view of one operating environment of the invention. In this, a conventional residential home 100 includes a plurality of windows 102 mounted into the walls of a conventional frame house 106 with an attached garage 108. The windows usually are factory framed and assembled and are delivered to a job site ready for hanging or installation.

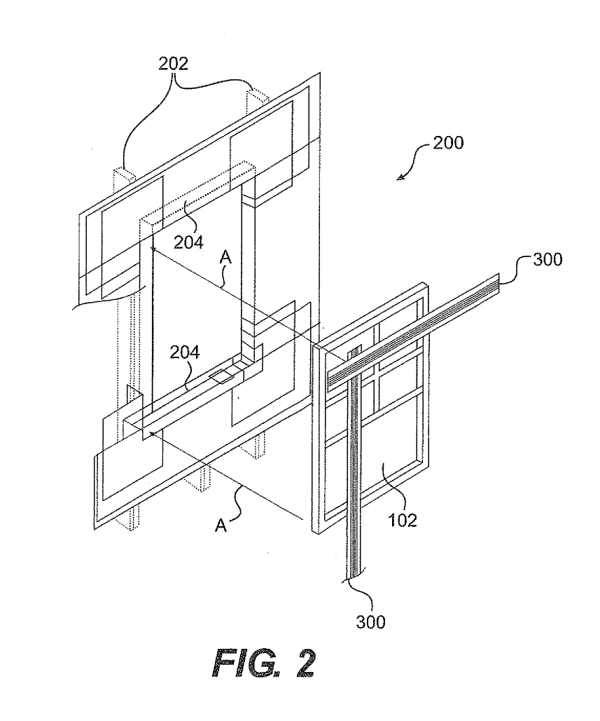

FIG. 2 discloses an exploded view of a conventional window and framing arrangement 200 where vertical 202 and horizontal 204 wall studs of the residence 100 are sized to accommodate factory installed framing 206 of a window 102. The window frame 206 is operable to be stapled or nailed to the studs 202 and 204 as indicated by directional arrows “A” in a conventional manner.

In order to complete a window installation and seal the window in place a laminated, see through, concealed, construction tape 300 is applied along the junction seam of the building framing studs 202 and 204 and window framing 206.

### Laminated, See Through, Construction Tape

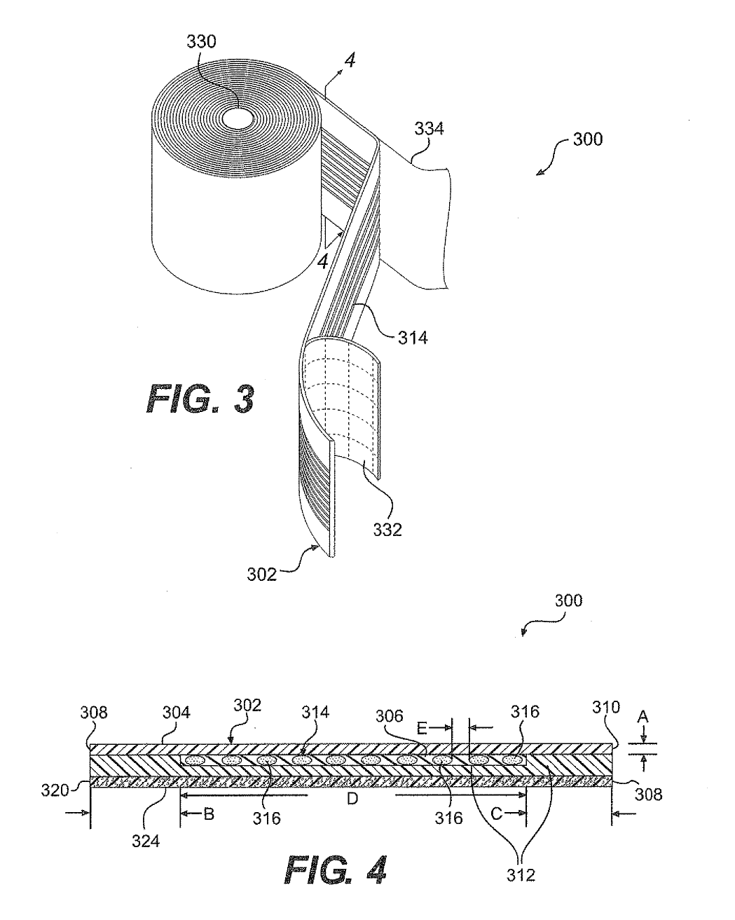

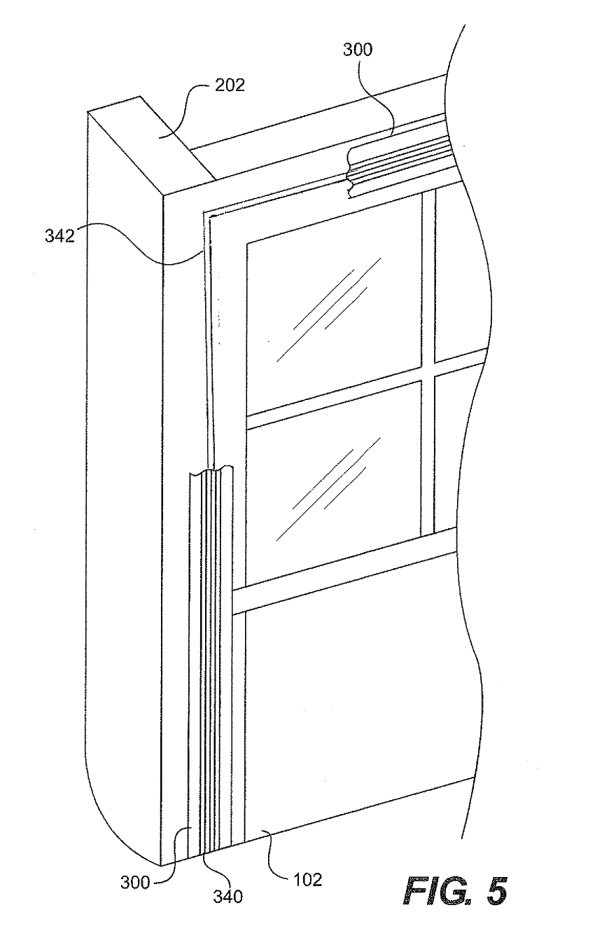

Turning now specifically to FIGS. 3 and 4 there will be seen detail views of a laminated, see through, constructed tape 300 in accordance with one specific embodiment of the invention. In this the construction tape 300 comprises a flexible, transparent polyester strip 302 having a first side 304 and a second side 306, a first edge 308 and a second edge 310. The thickness “A” of the transparent polyester strip for most construction projects is approximately two millimeters in a preferred embodiment.

A layer of transparent adhesive 312 is applied to the second side 304 of the polyester strip 302 along a central core region of the strip without extending to the edges 308 and 310 of the strip 302. In a preferred form the first layer of adhesive 312 is composed of water based ethylene vinyl acetate adhesive.

The lateral margins “B” and “C” that extend along the strip 302 can vary in width but in a preferred form comprise, in sum, between approximately twenty five percent (25%) and fifty percent (50%) of the width of the entire strip 302 with a preferred dimensional ratio being approximately thirty percent (30%). The total width of the laminated construction tape 300 can vary in accordance with the intended construction applications but the width is preferably about four inches in most applications. The sum of the laterally dimensions of the margins “B” and “C” in the most preferred form is approximately one point two inches for a four inch tape.

A core layer of reinforcing 314 comprises a band of substantially parallel, high denier, polyester yarns 316 extending coextensively with and are embedded within the first layer of transparent adhesive 312 along the center of the transparent polyester strip 302. In a preferred embodiment the substantially parallel polyester yarns have a denier of approximately 1513 grams per nine kilometers. The reinforcing provides structural integrity to the center region “D” of the strip 302 and is held in position by the first layer of transparent adhesive 312.

A second layer 320 of pressure sensitive, transparent, adhesive overlays the margins “B” and “C” as well as the core area “D” of the polyester strip 312 and thus across the core layer of reinforcing polyester yarns 314. The second layer of pressure sensitive adhesive (PSA) is composed of a transparent, acrylic pressure sensitive transfer adhesive having a high shear strength (dynamic shear of 14.7 psi to 17.4 psi) and a low glass transition (tacky to solid) temperature “Tg” of approximately minus 30 degrees centigrade so that the transparent, laminated construction tape 300 can be used in cold weather applications. The thickness of the margin regions “B” and “C” is enhanced and greater than the thickness of the core portion “D” of the pressure sensitive adhesive. One pressure sensitive adhesive that applicant has found suitable is VT 3600 or 3604 manufactured by the Venture Tape Corp. of Rockland, Mass. 02370.

As best seen in FIG. 4 the margin areas “B” and “C” of the pressure sensitive adhesive of the laminated, see through, construction tape are thicker than the center portion of the tape and in a preferred embodiment the PSA of the margin areas are twice as thick as in the PSA of the center of the tape to provide enhanced attachment capacity to an underlying building surface.

Finally the flexible, transparent construction tape 300 is provided with an outer release strip 324 that overlays the second layer of pressure sensitive adhesive 320. The release strip is composed of a high density polyethylene coated with a silicone release coating on the side adjacent to the second layer of pressure sensitive adhesive 320. In this form the laminated, see through, construction tape 300 is suitable to be manufactured and stored on a spool 330 for storage and delivery to a job site.

The release strip 324 includes, in one embodiment, an x-y pre-marked grid 332 to facilitate cutting and accurate application to a window frame seam or joint or the like. In addition the release strip is selected to by easily marked with a conventional ball point pen or carpenter's pencil to facilitate cutting and shaping to fit construction junctions.

A method of application of the laminated, see through, construction tape 300 of the subject invention includes unrolling a length of the tape 300 from spool 330 with a length calculated to fit the particular construction purpose. Exact lengths can be measured and marked on the release paper side of the tape. The tape 300 is then cut to length, as measured, and the release layer at one end is peeled away to permit initial see through application where the center of the tape 300 is applied to the seam line of the window building frame. As the laminated construction tape 300 is aligned and positioned for application the release layer 332 is pulled away permitting the second adhesive layer 320 to directly and firmly self adhere to the underlying construction junction. The relatively thicker edge margin areas “B” and “C” (approximately twice the thickness of a central region of the tape) provide secure adhesive contact with an underlying construction component which provides a water tight seal against lateral and/or longitudinal movement while the central portion of the tape 130 provides dimensional stability for the flashing project. In certain instances staples may be added along the margin regions “B” and “C” and in those instances the thickness of the margin adhesive acts as a self sealing compound around the staple or nail punctures into adjacent framing.

In the preceding specification use of the terms first and second are expressions of differentiation and while first has been used with respect to a side surface of the see through flashing construction tape 300 the designation is relational. In addition, preferred thicknesses and weight of components have been express as approximately. In this, although the ranges and specific values are preferred it is intended that the scope of the disclosure and claims are not to be limited to exactly the stated ranges and values but would also include equivalent values for the recited functions.

The preceding description has been presented to illustrate and describe the invention and some examples of its implementation. It is not intended to be exhaustive or to limit the invention to any precise form disclosed. Many modifications and variations are possible and would be envisioned by one of ordinary skill in the art in light of the above teaching.

The various aspects were chosen and described in order to best explain principles of the invention and its practical applications. The preceding description is intended to enable others skilled in the art to best utilize the invention in various embodiments and aspects and with various modifications as are suited to the particular use contemplated. It is intended that the scope of the invention be defined by the following claims; however, it is not intended that any order be presumed by the sequence of steps recited in the method claims unless a specific order is directly recited.

What is claimed is:

1. A laminated, see through, construction tape for uses in window flashing applications, and the like, said construction tape comprising:
a flexible, transparent strip having a first side and a second side and a first longitudinally extending edge and a second longitudinally extending edge;
a first layer of transparent adhesive extending along a central strip of said second side of said flexible, transparent strip;
a core layer of reinforcing extending along said first layer of transparent adhesive and comprising a plurality of strand bundles extending longitudinally along said flexible, transparent strip and each strand bundle being substantially mutually parallel and parallel with said first and second longitudinally extending edges of said flexible, transparent strip, said layer of reinforcing strand bundles having,
a plurality of fibers bundled into each strand,
a lateral gap between adjacent longitudinally extending strand bundles, and
said core layer of reinforcing strand bundles being laterally spaced from said first and second longitudinally extending edges of said flexible, transparent strip an amount that is substantially equal on each side and the sum of the spacing is approximately between twenty five percent and fifty percent of the overall width of said flexible transparent strip wherein said layer of transparent adhesive is exposed along each edge of said flexible, transparent strip and in addition between adjacent strand bundles of said layer of reinforcing;
a second layer of adhesive coextensively covering said core layer or reinforcing and an in addition extending to each edge of said flexible, transparent strip to be coextensive with said flexible, transparent strip; and
a release strip extending coextensively with and releasably adhered to said second layer of transparent adhesive along the exposed edges of said flexible, transparent strip and between said strand bundles of said layer of longitudinally extending reinforcing strand bundles, wherein upon removable of said release layer said laminated, see through, construction tape is operable to be visually aligned and adhered around a window casing, or the like, to provide secure flashing for a construction project.

2. A laminated, see through, construction tape for uses in window flashing applications, and the like as defined in claim 1, wherein said flexible, transparent strip comprises:
a polyester film of approximately 50 micron thickness.

3. A laminated, see through, construction tape for uses in window flashing applications, and the like, as defined in claim 1 wherein said transparent adhesive comprises:
a water based ethylene vinyl acetate adhesive.

4. A laminated, see through, construction tape for uses in window flashing applications, and the like, as defined in claim 1 wherein said plurality of fibers bundled into strands are composed of:
polyester yarn having a denier of approximately 1513 grams per nine kilometers.

5. A laminated, see through, construction tape for uses in window flashing applications, and the like, as defined in claim 4 wherein:
the percent elongation before breakage of said polyester yarn is approximately 10%.

6. A laminated, see through, construction tape for uses in window flashing applications, and the like, as defined in claim 1 wherein:
the lateral spacing between strands of fiber bundles in the layer of reinforcing is approximately equal to width of the fiber bundles adjacent the spacing.

7. A laminated, see through, construction tape for uses in window flashing applications, and the like, as defined in claim 1 wherein:
said lateral spacing between said core layer of reinforcing strand bundles from said first and second longitudinally extending edges of said flexible transparent strip is approximately thirty percent of the width of said construction tape and the thickness of the pressure sensitive adhesive in the lateral spacing being approximately twice the thickness of the of the pressure sensitive adhesive in the central region.

8. A laminated, see through, construction tape for uses in window flashing applications, and the like, as defined in claim 1 wherein:
said release strip comprises a high density polyethylene coated with a silicone release coating on the side adjacent said layer of reinforcing and transparent adhesive.

9. A laminated, see through, construction tape for uses in window flashing applications, and the like, as defined in claim 8 wherein:
said release strip includes orthogonal pre-marking for pattern cutting of said laminated, see through, construction tape before application.

10. A laminated, see through, construction tape for uses in window flashing applications, and the like, as defined in claim 8 wherein:
the outer layer of said release strip being operable to receive ball point pen marking for pattern cutting of said laminated, see through, construction tape before application.

11. A laminated, partially transparent, construction tape for uses in window flashing applications, and the like, said construction tape comprising:
a flexible, transparent strip of polyester film having a first side and a second side and a first longitudinally extending edge and a second longitudinally extending edge;
a layer of transparent adhesive coextensively covering said second side of said flexible, transparent strip;
a core layer of reinforcing comprising a plurality of strand bundles extending longitudinally along said flexible, transparent strip and each strand bundle being substantially mutually parallel and parallel with said first and second longitudinally extending edges of said flexible, transparent strip, said layer of reinforcing strand bundles having,
a plurality of fibers bundled into each strand, and
a lateral gap between adjacent longitudinally extending strand bundles;
said core layer of reinforcing being laterally spaced from said first and second longitudinally extending edges of said flexible, transparent strip of polyester film,
the lateral space by said core layer of reinforcing from said first and second longitudinal edges of said flexible, transparent strip is substantially equal on each side and the sum of the spacing is approximately equal to thirty percent of the width of said flexible, transparent strip of polyester film;
a second layer of adhesive coextensively covering said core layer or reinforcing and an in addition extending to each edge of said flexible, transparent strip to be coextensive with said flexible, transparent strip; and
a release strip extending coextensively with and releasably adhered to said second layer of transparent adhesive at least between said strand bundles of said layer of longitudinally extending reinforcing strand bundles, wherein upon removable of said release layer said laminated, see through, construction tape is operable to be visually aligned and adhered around a window casing, or the like, to provide secure flashing for a construction project.

12. A laminated, partially transparent, construction tape for uses in window flashing applications, and the like, as defined in claim 11 wherein:
said transparent strip of polyester film has a thickness of approximately 50 microns.

13. A laminated, partially transparent, construction tape for uses in window flashing applications, and the like, as defined in claim 12 wherein said transparent adhesive comprises:
an ethylene vinyl acetate adhesive.

14. A laminated, partially transparent, construction tape for uses in window flashing applications, and the like, as defined in claim 13 wherein:
said layer of reinforcing strand bundles being laterally spaced by approximately half an inch from each of said first and second longitudinally extending edges of said flexible, transparent strip wherein said layer of transparent adhesive is exposed along each edge of said flexible, transparent strip and in addition between adjacent strand bundles of said layer of reinforcing.

15. A laminated, partially transparent, construction tape for uses in window flashing applications, and the like, as defined in claim 12 wherein said plurality of fibers bundled into strands are composed of:
polyester yarn having a denier of approximately between 1479 and 1547 grams per nine kilometers.

16. A laminated, partially transparent, construction tape for uses in window flashing applications, and the like, as defined in claim 15 wherein: the break load of each of said strands of fibers:
the break load of each of said strand bundles of fibers is approximately between 11148 and 12996 grams where said fibers have approximately 2.0 twists per inch.

17. A laminated, partially transparent, construction tape for uses in window flashing applications, and the like, as defined in claim 16 wherein:
the percent elongation before breakage of said polyester yarn is approximately 10%.

18. A laminated, partially transparent, construction tape for uses in window flashing applications, and the like, as defined in claim 14 wherein:
the lateral spacing between strands of fiber bundles in the layer of reinforcing is approximately equal to width of the fiber bundles adjacent the spacing.

19. A laminated, partially transparent, construction tape for uses in window flashing applications, and the like, as defined in claim 15 wherein:
said release strip comprises a high density polyethylene coated with a silicone release coating on the side adjacent said layer of reinforcing and transparent adhesive.

20. A laminated, partially transparent, construction tape for uses in window flashing applications, and the like, as defined in claim 19 wherein:
said release strip includes orthogonal pre-marking for pattern cutting of said laminated, see through, construction tape before application.

21. A laminated, partially transparent, construction tape for uses in window flashing applications, and the like, as defined in claim 19 wherein:
the outer layer of said release strip being operable to receive ball point pen marking for pattern cutting of said laminated, partially transparent, construction tape before application.
